(19) United States
(12) Patent Application Publication
(10) Pub. No.: US 2014/0219586 A1
(43) Pub. Date: Aug. 7, 2014

(54) ULTRASONICALLY WELDED LATERAL SEALS

(71) Applicant: MULTISORB TECHNOLOGIES, INC., Buffalo, NY (US)

(72) Inventors: Allen DeFedericis, Alden, NY (US); Anthony J. Arnone, West Valley, NY (US)

(73) Assignee: MULTISORB TECHNOLOGIES, INC., Buffalo, NY (US)

(21) Appl. No.: 13/762,167

(22) Filed: Feb. 7, 2013

(51) Int. Cl. B32B 37/00; B65D 33/00

(52) U.S. Cl. CPC B32B 37/0046; B65D 33/00
USPC 383/107; 156/580.2; 156/73.1

(57) ABSTRACT

A horn for an ultrasonic welder includes a pattern of knurls on a face of the horn. The knurls are spaced by a pattern of indentations including fist indentations formed a first depth from a contact plane and second indentations formed a second depth from the contact plane.

### BACKGROUND OF THE INVENTION

1. Technical Field

This invention relates to ultrasonic welding. More specifically, it relates to an improved ultrasonic welding horn particularly useful for forming lateral seals material having varied thickness.

2. Description of Related Art

Sorbents and especially desiccants are conventionally provided to customers as sachets or packets provided in long continuous strips or bandoliers. Automated high speed machines and methods for manufacturing such products and for dispensing such products are relatively well-known. While no particular minimum number of packets per bandolier has developed, very large spools of packets are available with individual packets numbering up to 10,000 or 15,000 available in a continuous strip for automatic separation and insertion into products.

Because one of the functions of such conventional packets is to absorb moisture in packaging for the purpose of extending shelf life and preserving potency of the packaged products, the package for such sorbents is usually porous or permeable to moisture. While a number of materials have been used over the years to provide the combination of strength and porosity or permeability to moisture that is required for the products, Tyvek-brand non-woven materials are especially popular. Non-woven's are both strong and porous and automated methods for the manufacture and insertion of packets made from non-woven materials are conventionally known.

Typically, a strip of non-woven material as long as or longer than the desired length the strip of packets is provided to a filling machine. The filling machine sequentially rolls the strip of material around a mandrill and forms a continuous or intermittent elongated longitudinal seal by either overlapping the edges of the non-woven material or forming a fin by sealing the facing edges of the non-woven material together.

A first lateral seal is formed transversely with respect to the length of the strip of packaging material and a quantity of a sorbent, more particularly a quantity of desiccant, is inserted into the open tubular packet. A second lateral seal is then formed transversely with respect to the packaging material to form a first closed packet of sorbent and to form the bottom seal of the next packet. The process is repeated until the length of packaging material is exhausted or until the desired number of packets has been formed.

The lateral seals formed in the method just described are often formed using heat and pressure or via ultrasonic welding. The heat bar and the ultrasonic weld horn used in these respective processes often have a pattern formed thereon that includes raised surfaces and indentations, such that a patterned weld is created. Conventional patterns include a series of longitudinal lines and criss-crossing lines that form a pattern of diamonds on the lateral seal.

In conventional designs the portions of the packet that are contacted by the raised surfaces on the welding tool become substantially transparent. For example, a weld tool that includes a series of raised diamond-shaped features will result in a weld seal having substantially transparent diamonds outlined by opaque diagonal lines. In some applications this transparency is important. For example, packing machines that automatically separate the successive packets often will use a sensor that senses light passing through the transparent section of packets. More specifically, the sensed light indicates a sealing area, at which adjacent packets are to be separated by cutting across the seal.

An inherent problem in the formation of the lateral seals has to do with construction of the sachet. Specifically, the lateral seal is not uniform. As discussed above, the longitudinal seal, which may be formed either by overlapping the edges of the web used to form the sachet or by creating a fin at those edges, runs along the entire length of each of the sachets. The longitudinal seal increases the thickness of the lateral seal in those segments in which it is present. Where the longitudinal seal is present, for example, the thickness of the lateral seal is doubled.

This extra material has presented complications in the manufacturing process. In some instances, the seal is relatively weak, or worse faulty, where the lateral seal includes the longitudinal seal. Moreover, even when a good seal is accomplished, the extra material often results in a less aesthetically-pleasing seal.

Accordingly, there is a need for an improved welding tool that creates a uniform lateral seal in conventional packages.

There also exists a need for an improved welding tool that creates such a uniform seal across multiple thicknesses in the same seal.

### SUMMARY OF THE INVENTION

The present disclosure remedies the foregoing needs in the art.

In one aspect of the disclosure, a horn for an ultrasonic welder includes a pattern of knurls on a face of the horn. The knurls are spaced by a pattern of indentations including first indentations formed a first depth from a contact plane and second indentations formed a second depth from the contact plane.

In another aspect of the invention, a horn for an ultrasonic welder includes one or more first valleys formed in a face of the horn, each having a first valley angle, and one or more second valleys formed in the face, each having a second valley angle.

In yet another aspect of the invention, a method of forming a packet having spaced lateral seals includes shaping a web of material into a packet having an open end and ultrasonically sealing the open end by applying a horn to the material. The horn includes a pattern of indentations comprising first indentations having a first depth relative to a contact plane and second indentations having a second depth relative to the contact plane.

In still another aspect of the invention, a packet includes a lateral seal comprising a pattern of lateral lines and longitudinal lines defining there between substantially transparent segments, at least one of (i) a first of the lateral lines having a different width than a second of the lateral lines and (ii) a first of the longitudinal lines having a different width than a second of the lateral lines.

These and other aspects, features, and benefits of the invention will be appreciated. further with reference to the following detailed description of the invention and accompanying figures, in which preferred embodiments are described and illustrated.

### BRIEF DESCRIPTION OF THE DRAWING FIGURES

FIGS. 1A and 1B are, respectively, a perspective view and a cross-sectional view of a conventional sachet or packet.

FIG. 2 is a perspective view of a horn for an ultrasonic welding application according to one embodiment of the invention.

FIGS. 3A and 3B are cross-sectional views of an embodiment of a face of the horn of Figure, taken along section lines A-A and B-B, respectively.

FIGS. 4A and 4B are cross-sectional views of an embodiment of a face of the horn of Figure, taken along section lines A-A and respectively.

FIGS. 5A and 5B are cross-sectional views of an embodiment of a face of the horn of Figure, taken along section lines A-A and B-B, respectively.

FIGS. 6A and 6B are cross-sectional views of an embodiment of a face of the horn of Figure, taken along section lines A-A and B-B, respectively.

FIGS. 7A and 7B are cross-sectional views of an embodiment of a face of the horn of Figure, taken along section lines A-A and B-B, respectively.

### DETAILED DESCRIPTION OF THE INVENTION

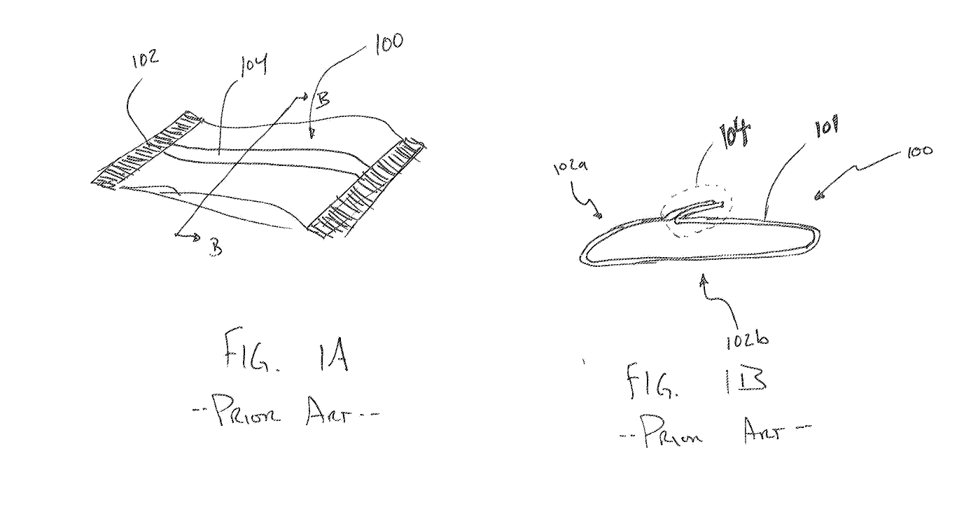

Preferred embodiments of the invention now will be described with reference to the Figures. FIGS. 1A and 1B illustrate a conventional sachet 100 such as those described above in the Background of the Invention section. The sachet 100 generally includes a body made by folding a web of material 101, such as anon-woven material, to bring opposite longitudinal edges together, and sealing those edges to create the longitudinal seal 104, which is formed as a fin. Lateral seals 102 are spaced along the longitudinal direction, perpendicular to the longitudinal seal 104. As illustrated, and as should be appreciated, the lateral seals bond two thicknesses of the web proximate edges 102a of the seal and four thicknesses of the web, i.e., because of the presence of the fin, proximate the center 102b of the packet.

Although embodiments of the invention are particularly useful at creating sachets such as those illustrated in FIGS. 1A and 1B, the invention is not limited to this application. Other welding applications, particularly those that have varied thickness of material to be welded, may also benefit from the invention.

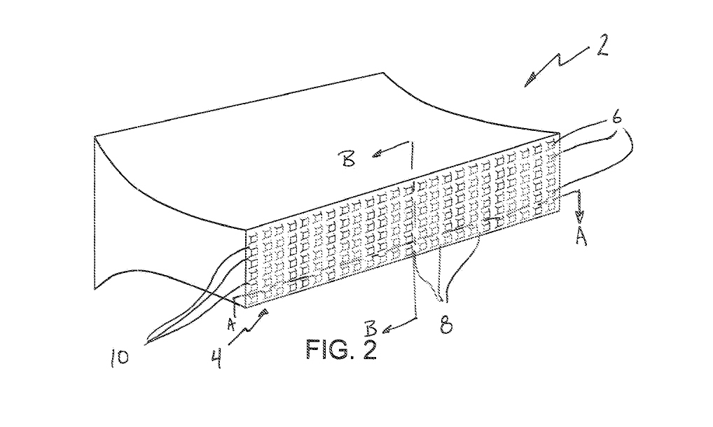

FIG. 2 shows a horn 2 for an ultrasonic welder. Because ultrasonic welding and apparatus for ultrasonic welding are well known in the art, the other components of the ultrasonic welder are not illustrated and will not be described in detail herein.

The horn 2 includes a face 4. In operation, the material to be welded is pressed between the face 4 and an anvil (not shown) and a low-amplitude acoustic vibration is emitted to form the seal.

The face 4 has a pattern formed thereon, In the illustration of FIG. 2, a pattern of knurls 6 is provided. The knurls 6 are raised relative to indentations that separate the knurls 6. In the embodiment illustrated, the indentations comprise vertical or longitudinal valleys 8 and horizontal or lateral valleys 10. In one embodiment, the face 4 is fabricated by cutting the vertical valleys 8 and the horizontal valleys 10 using a scoring or similar cutting tool. The result is a mesh of valleys intersecting at right angles with the knurls 6 being the uncut or unscored sections between the intersections.

FIG. 2 is a representative illustration of one pattern of knurls 6 and interspaced valleys 8, 10. The knurls in FIG. 2 are meant to be nominal knurls 6, with more specific configurations of the knurls being described and illustrated in the additional Figures.

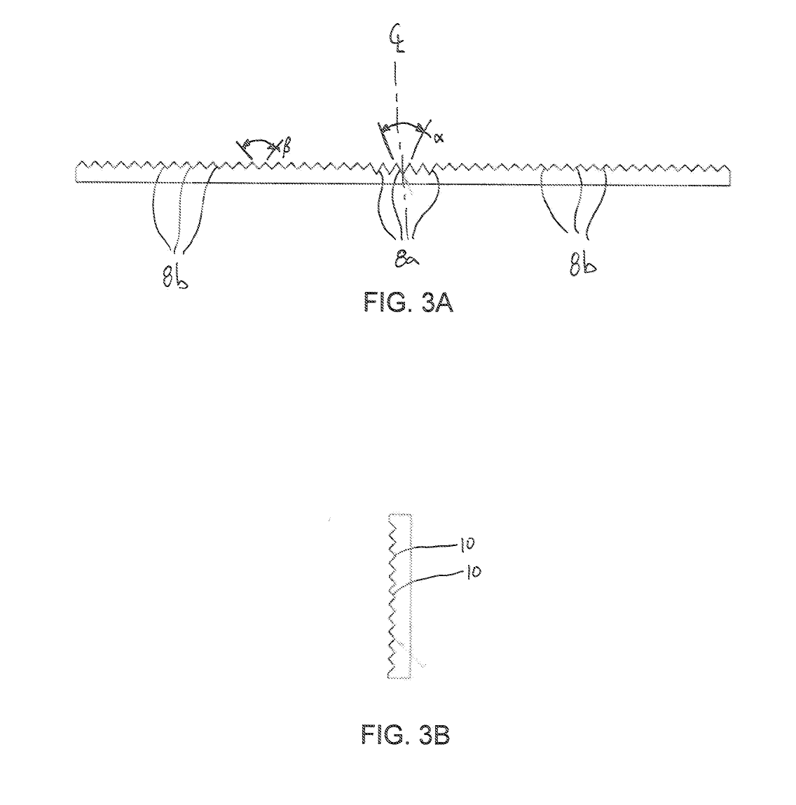

FIGS. 3A and 3B illustrate one example of cross-sections according to one embodiment of the face 4, taken along section lines A-A and B-B, respectively.

In FIG. 3A, the cross-section of the vertical valleys 8 is shown. Specifically, in this embodiment the valleys 8 include first vertical or longitudinal valleys 8a proximate a center of the face and second vertical or longitudinal valleys 8b outside the first vertical valleys, i.e., farther from the centerline of the face. The first vertical valleys 8a extend deeper into the face than do the second vertical valleys 8b. As should be appreciated, when a lateral seal of a sachet is formed as in the methods described above, the portion of the sachet having the longitudinal seal 104 is arranged over the first vertical valleys to create the lateral seal. In this manner, the increased thickness resulting from the longitudinal seal is accommodated by the deeper valleys.

As also illustrated in FIG. 3A, the first vertical valleys 8a have a first valley angle α, different from a corresponding valley angle β, of the second vertical valleys 8b. In the illustration, the first valley angle a is smaller than the second valley angle β. With this arrangement, the depth of the first valleys may be deeper without an appreciable difference in width between the knurls formed on either side of the valley. In one preferred embodiment, the first valley angle α is 60-degrees and the second valley angle β is 90-degrees.

In other embodiments, the first and second valley angles may be the same, but the second valleys may still be deeper. This will result in a greater width between knurls formed between the second valleys, but such is not necessarily undesirable.

FIG. 3B shows in cross-section the horizontal or lateral valleys 10. In this embodiment, the valleys are uniformly sized and shaped, and each has substantially the same valley angle.

As will be appreciated, the configuration illustrated in FIGS. 3A and 3B has a differing profile in the lateral direction, to accommodate for the fact that more layers of material are welded together at the longitudinal seal than at areas away from the longitudinal seal. Put another way, the characteristics of the material, specifically its thickness, comprising the packet at the lateral seal change in the lateral direction. Because those characteristics are uniform in the longitudinal direction, there may be no need for a varying profile in the longitudinal direction; thus this embodiment has no variation in the longitudinal direction.

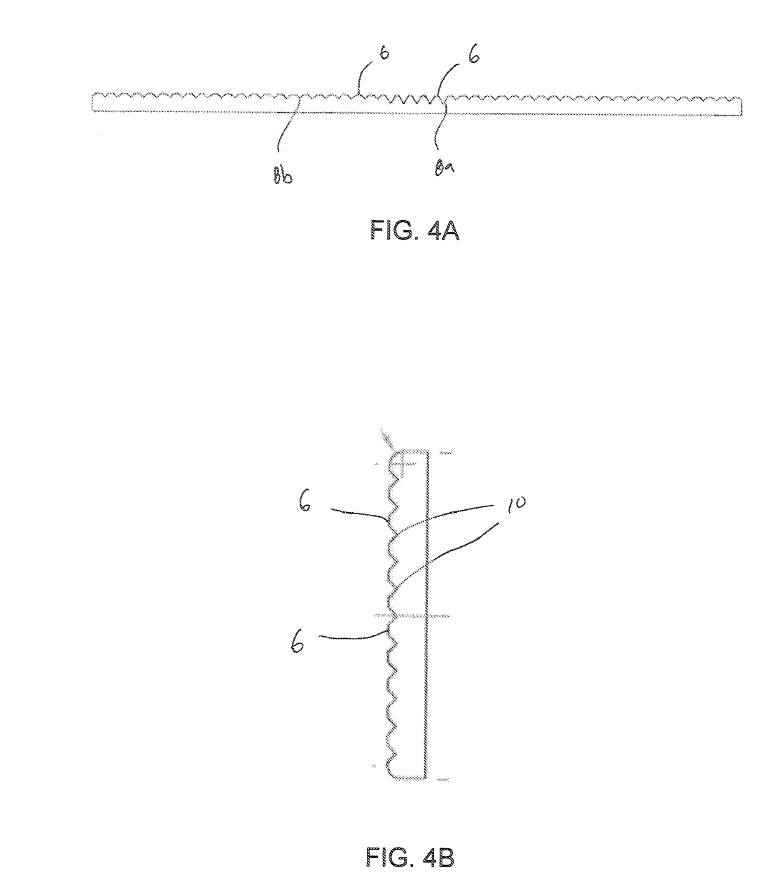

In FIGS. 3A and 3B, the knurls 6 peak at points. The peaks are formed by machining the valleys sufficiently close that only a point remains between the valleys. FIGS. 4A and 4B are substantially identical to FIGS. 3A and 3B, except that the peaks are truncated, to form substantially flat peaks (plateaus) as the knurls 6. The flat knurls 6 may be formed by spacing the valleys farther away, thus leaving part of the original face of the horn, or by forming pointed knurls as in FIGS. 3A and 3B, and machining all of the knurls 6 to form a substantially planar contact surface, consisting of each of the knurls. In the illustrated embodiment, the knurls are truncated after being formed as peaks, which results in a shallower depth of the vertical and horizontal valleys (relative to the contact plane defined by the peaks of the respective knurls 6) in FIGS. 4A and 4B than in FIGS. 3A and 3B. Practically, the flat knurls 6 will form larger transparent windows than will the pointed knurls 6, but they also may require more energy to form those larger windows.

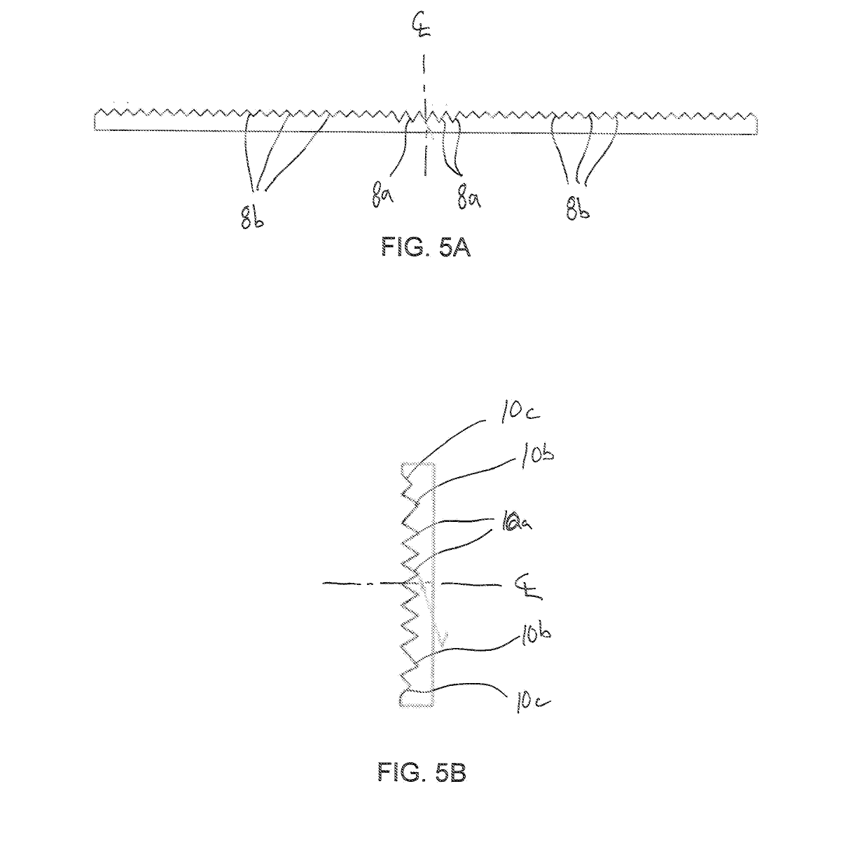

FIGS. 5A and 5B illustrate another pattern. FIG. 5A is substantially identical to FIG. 3A, having first vertical valleys 8a proximate the centerline and second, shallower vertical valleys 8b farther from the centerline. FIG. 5B is different from FIG. 3B, however, in that it has a varied profile. It includes first horizontal valleys 10a proximate the centerline, second horizontal valleys 10b further from the centerline, and third horizontal valleys 10c further still from the centerline, proximate edges of the face. As illustrated, the first horizontal valleys are deeper and have a smaller valley angle than the second horizontal valleys 10b, which are deeper and narrower still than the third horizontal valleys 10c. In one embodiment, the first horizontal valleys have a valley angle of 60-degrees, the second valleys have a valley angle of 75-degrees, and the third valleys have a valley angle of 90-degrees.

The arrangement of the valleys in FIG. 5B provides for a different aesthetic than the arrangements of FIGS. 3B and 4B. Specifically, although the windows formed at each of the knurls will be relatively uniform, the knurls will be spaced differently nearer the longitudinal edges of the seal.

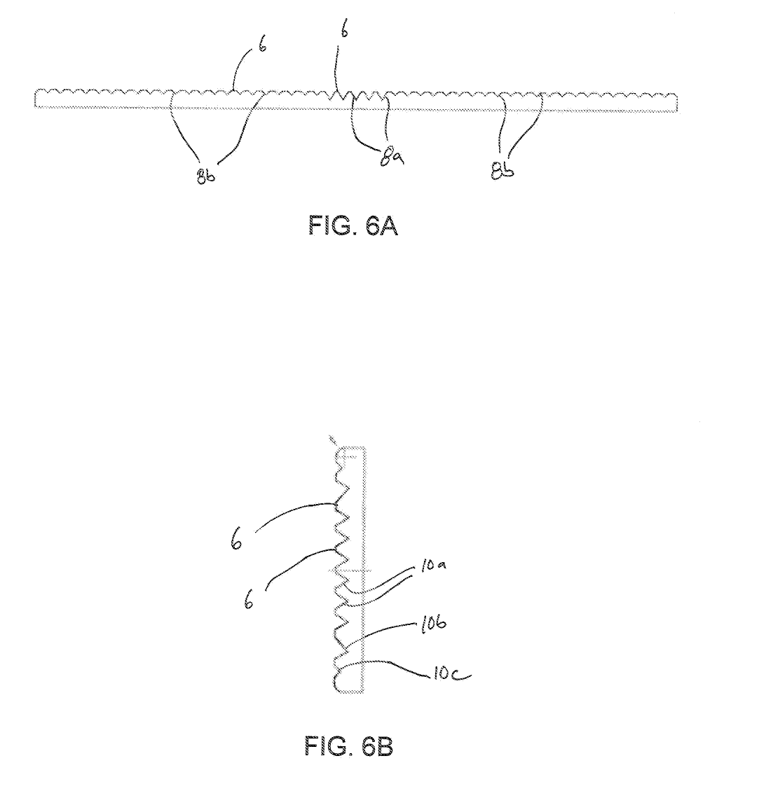

FIGS. 6A and 6B are the same as FIGS. 5A and 5B, except that the knurls 6 are truncated, as illustrated in, and described above with respect to, FIGS. 4A and 4B.

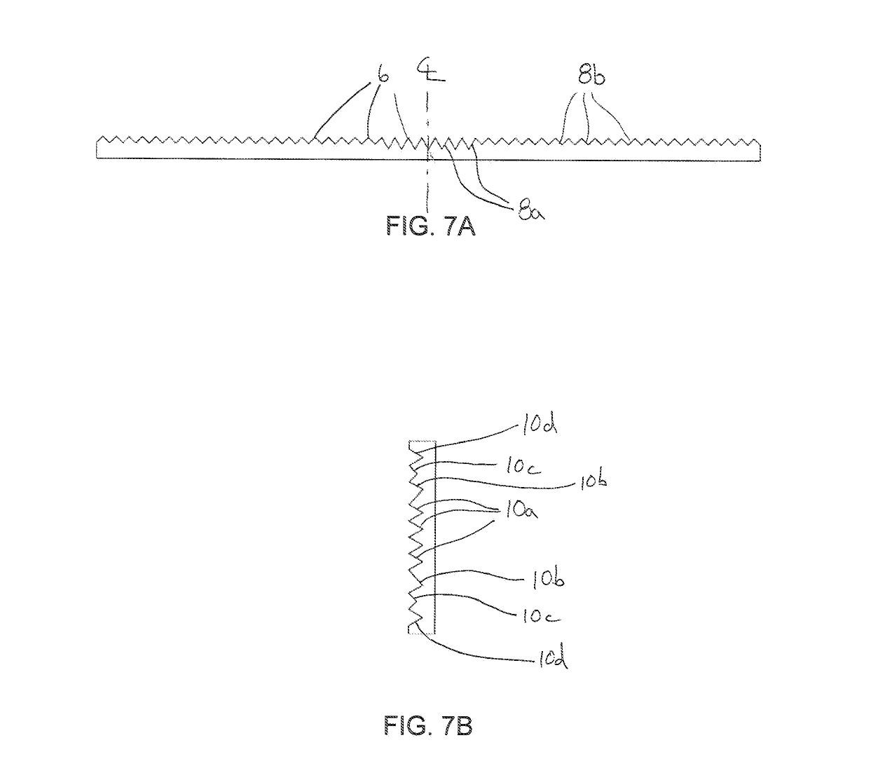

FIGS. 7A and 7B illustrate yet another pattern. FIG. 7A shows a face that is similar to that of FIG. 5A, having first vertical valleys 8a proximate the centerline and second, shallower vertical valleys 8b further from the centerline.

FIG. 7B, like that of FIG. 5B, shows a varied profile. But, it's a different varied profile. The varied (profile includes first horizontal valleys 10a proximate the centerline, second valleys 10b further from the centerline, third valleys 10c further still from the centerline, and fourth horizontal valleys 10d proximate edges of the face, In the illustrated embodiment, the first and fourth horizontal valleys 10a, 10d are equal in depth and valley angle. Also as illustrated, the first horizontal valleys 10a are deeper and have a smaller valley angle than the second horizontal valleys 10b, which are deeper and narrower still than the third horizontal valleys 10c. In the design of FIG. 713, two of the first horizontal valleys are moved “outside” of the third vertical valleys, to the edge of the face, to provide a relatively deeper knurl at each edge. The inventors have found that these fourth horizontal valleys 10d create a transition from the shallower knurls formed by the third horizontal valleys 10c to the unwelded material comprising the remainder of the packet. This transition prevents the horn face from contacting the packet material.

Although not required, in one embodiment, the first and fourth horizontal valleys 10a have a valley angle of 60-degrees, the second valleys have a valley angle of 75-degrees, and the third valleys have a valley angle of 90-degrees.

In embodiments described above, the knurls all peak at substantially the same level, i.e., their peaks are substantially co-planar. This is not required. For example, the knurls proximate the centerline of the face may be shorter, i.e., terminate at a peak lower, than the knurls farther from the centerline. This may help to accommodate the increased thickness of the packet at the longitudinal seal. In that instance, the anvil may be stepped, such that the peaks of the knurls near the centerline will still contact the anvil, but this is not required.

Also in the embodiments described above, each of the designs provides a pattern of valleys (and thus of knurls) that is substantially symmetrical about a centerline. Many of the embodiments use this preferred arrangement because the longitudinal seal is located substantially centrally on the packet, but this is not required, The seal may be other than central, so the pattern of valleys may be adjusted to accommodate for a differently-located seal. Even if the seal is centrally located, there is no requirement that the pattern be symmetrical. Varying the pattern may create a unique aesthetic, for example, and one of ordinary skill in the art will appreciate other reasons for designing the pattern other than symmetrical.

Other modifications and embodiments also are contemplated. For example, although the valleys are illustrated and described as being horizontal and vertical, such is not required. The valleys may be formed at angles relative to the lateral and longitudinal directions, which will result in a pattern of diamond-shaped knurls, instead of the substantially square knurls shown above. Similarly, the lateral seal may be formed using a horn having only the vertical valleys or only the horizontal valleys. In this configuration, the face of the horn would have a pattern of parallel “ridges” instead of the knurls illustrated in the Figures described above. The resulting sachet would have substantially transparent vertical or horizontal parallel lines, separated by opaque, parallel lines. In still other embodiments, the valleys need not be straight lines. Arcuate or even random valleys could be provided, for example, to provide a unique aesthetic. In still other embodiments, a logo or trademark may be formed using the valleys, so the lateral seal includes a brand identification. In each of these, however, the valleys have preferably two depths, two valley angles, or both.

The embodiments described above all contemplate a pattern formed on an ultrasonic horn. Those of ordinary skill in the art understand that an ultrasonic weld is formed in material positioned between the horn and an anvil. There is no requirement that the patterns described above be formed on the horn. The pattern my instead be formed on the anvil, with the horn having a substantially flat surface. In still other embodiments, a portion of the pattern is formed on the horn and the remainder of the pattern is formed on the anvil. For example, the horizontal valleys could be formed on the horn and the vertical valleys on the anvil, or vice versa.

While the invention has been described in connection with several presently preferred embodiments thereof, those skilled in the art will appreciate that many modifications and changes may be made therein without departing from the true spirit and scope of the invention which accordingly is intended to be defined solely by the appended claims.

1. An ultrasonic welding apparatus comprising:
an anvil;
a horn arranged proximate the anvil to ultrasonically weld material placed between the anvil and the horn; and
a pattern of knurls on a face of at least one of the horn and the anvil spaced by a pattern of indentations, the pattern of indentations comprising first indentations formed a first depth from a contact plane and second indentations formed a second depth from the contact plane.

2. The welder of claim 1, wherein the face is coplanar with the contact plane.

3. The apparatus of claim 1, wherein at least some of the knurls terminate at peaks co-planar with the contact plane.

4. The apparatus of claim 3, wherein each peak between adjacent first indentations is co-planar with the contact plane and each peak between adjacent second indentations is offset relative to the contact plane.

5. The apparatus of claim 1, wherein the pattern of indentations comprises at least one of a plurality of longitudinal valleys and a plurality of lateral valleys formed in a face of at least one of the horn and the anvil.

6. The apparatus of claim 5, wherein at least one of the lateral valleys has a different angle than other of the lateral valleys,

7. The apparatus of claim 5, wherein at least one of the longitudinal valleys has a different angle than other of the longitudinal valleys.

8. The apparatus of claim 5, wherein the at least one of the plurality of longitudinal valleys and the plurality of lateral valleys is symmetrical about a center line.

9. The apparatus of claim 2, wherein the ridges are truncated.

10. The apparatus of claim 1, wherein the pattern is formed entirely on either the horn or the anvil.

11. An ultrasonic welding apparatus comprising:
an anvil;
a horn arranged proximate the anvil to ultrasonically weld material disposed between the anvil and the horn;
one or more first valleys formed in a face of at least one of the anvil and the horn, each having a first valley angle; and
one or more second valleys formed in the face, each having a second valley angle.

12. The apparatus of claim 11, wherein the first valleys are parallel.

13. The apparatus of claim 11, wherein the first valleys are arranged closer to a centerline of the thee and the second valleys are arranged relatively farther from the centerline.

14. The apparatus of claim 13, wherein the first valley angle is larger than the second valley angle.

15. The apparatus of claim 13, wherein the first valleys are deeper relative to the face than the second valleys.

16. The apparatus of claim 11, wherein one of the first valleys has a first depth relative to the face and at least one of the other first valleys has a second depth relative to the face.

17. The apparatus of claim 11, wherein one of the first valleys has a first depth relative to the face and at least one of the second valleys has a second depth relative to the face.

18. The apparatus of claim 11, further comprising:
third valleys formed in the face, angled relative to the first and second valleys.

19. The horn of claim 18, wherein the third valleys are substantially perpendicular to the first and second valleys, and knurls are formed adjacent to intersections of the third valleys with the first and second valleys.

20. The horn of claim 19, wherein the knurls are truncated.

21. A method of forming a packet having spaced lateral seals, the method comprising:
shaping a web of material into a packet having an open end; and
ultrasonically sealing the open end by applying a horn to the material the horn including a pattern of indentations comprising first indentations having a first depth relative to a contact plane and second indentations having a second depth relative to the contact plane.

22. A packet comprising:
a lateral seal comprising a pattern of lateral lines and longitudinal lines defining there between substantially transparent segments, at least one of (i) a first of the lateral lines having a different width than a second of the lateral lines and (ii) a first of the longitudinal lines having a different width than a second of the lateral lines.

23. The packet of claim 22, wherein the lateral seal has a first segment in which two layers of a material forming the packet are sealed together and a second segment in which more than two layers of the material forming the packet are sealed together.

24. The packet of claim 23, wherein the lateral lines are relatively narrower in the first segment and relatively wider in the second segment.
